(19) United States
(12) Patent Application Publication
(10) Pub. No.: US 2006/0154645 A1
(43) Pub. Date: Jul. 13, 2006

(54) Controlling network access

(75) Inventor: Sander Van Valkenburg, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/121,999

(22) Filed: May 5, 2005

(30) Foreign Application Priority Data
Jan. 10, 2005 (FI) 20050022

(51) Int. Cl. H04M 1/66

(52) U.S. Cl. 455/411

(57) ABSTRACT

In a method for controlling network access, identity information for authentication is received from a communications device in a network. When the identity information indicates an identity module, the identity module is authentication. The identity module relates to the communications device, and it is associated with a further network. In response to a successful authentication of the identity module, access is granted to the communications device to a set of services of the further network. When the identity information indicates the communications device, the communications device is authenticated. In response to a successful authentication of the communications device, access is granted to the communications device to a subset of the set of services of the further network.

### BACKGROUND OF THE INVENTION

1. Field of the Invention

The present invention relates to controlling access to communications networks. In particularly, the invention relates to authentication of a communications device.

2. Related Art

A communication system can be seen as a facility that enables communication between two or more entities such as user equipment and/or other nodes associated with the system. The communication may comprise, for example, communication of voice, data, multimedia and so on. The communication system may be circuit switched or packet switched. The communication system may be configured to provide wireless communication. Communication systems able to support mobility of communications devices across a large geographic area are generally called mobile communications system. In cellular communication systems a communications device typically changed the cell via which it communicates. Some examples of a cellular communications system are the Global System for Mobile Telecommunications (GSM) and the Universal Mobile Telecommunications System (UMTS).

Traditionally public mobile communications systems have used licensed radio frequencies, which means use of a radio frequency band allocated to mobile telephone networks by national or international authorities or organizations. Recently, alternative methods for accessing mobile communications systems have been introduced. For example, a wireless local area network (WLAN) or any other wireless network may be operably connected to a mobile communications system, typically via a packet-switched network and a gateway. A communications device may establish a packet data connection to the gateway, which then provides access to the mobile communication system for the communications device by relaying user-plane data and control-plane signaling between the communications device and the mobile communications system. The wireless network may use a radio frequency different from the frequency band used by a mobile communications system, and typically the communication protocols used in the short-range wireless network are different from the communication protocols used in the mobile communications system. Unlicensed Mobile Access (UMA) and the 3rd Generation Partnership Project (3GPP) WLAN Interworking are examples of proposals for providing access to a mobile communications system via a wireless network.

In mobile communications systems, a communications device or a separate identity module operably connected to the communications device is typically authenticated before access is granted for the communications device to the mobile communications system. Typically the identity module is a smart card inserted to a suitable slot in the communications device. An identity module is typically associated with a subscriber or a user, and the subscriber/user may easily change communications devices by placing the identity module to another communications device.

In many mobile communications system, where authentication is based on the identity module, it is possible to make emergency calls even if there is no identity module operably connected to the communications device. The current alternative methods of accessing a mobile communications system via a further wireless network require the presence of an identity module. The gateway between the further wireless network and the mobile communications network provides access to the mobile communications system only after the communications device has been successfully authenticated, and authentication of the communications device towards the further wireless network is based on the identity information stored in the identity module. It is therefore not possible to place any calls without an identity module, when a mobile communications system is accessed via a further wireless network. However, it is expected that in some countries the regulator may require that emergency calls should be possible without identity module also when alternative access networks are used.

It is appreciated that although above authenticating a communications device using authentication methods of a mobile communications system has been discussed, similar problems may arise in authenticating a communications device towards a first network using authentication method relating to any second network.

Embodiments of the present invention aim to address at least some of the problems discussed above.

### SUMMARY OF THE INVENTION

A first aspect of the invention relates to a method for controlling network access, the method comprising

receiving identity information for authentication from a communications device in a network,

authenticating an identity module relating to the communications device and associated with a further network, when the identity information indicates the identity module,

granting to the communications device access to a set of services of a further network in response to a successful authentication of the identity module,

authenticating the communications device, when the identity information indicates the communications device, and

granting to the communications device access to a subset of the set of services of the further network in response to a successful authentication of the communications device.

A second aspect of the invention relates to a communications network, configured to

receive identity information for authentication from a communications device,

authenticate an identity module relating to the communications device and associated with a further network, when the identity information indicates the identity module,

grant to the communications device access to a set of services of the further network in response to a successful authentication of the identity module,

authenticate the communications device, when the identity information indicates the communications device, and

grant to the communications device access to a subset of the set of services of the further network in response to a successful authentication of the communications device.

A third aspect of the invention relates to a network element, configured to

receive identity information for authentication from a communications device,

authenticate an identity module relating to the communications device and associated with a further network, when the identity information indicates the identity module, and

authenticate the communications device, when the identity information indicates the communications device.

A fourth aspect of the invention relates to a method of operating a communications device, the method comprising

exchanging authentication protocol messages with a network,

authenticating an identity module associated with a further network, when the identity module is operably connected to the communications device,

storing identity information of the communications device and authentication information relating to the identity information, and

indicating to the network that the communications device is to be authenticated based on the identity information of the communications device, when no identity module is operably connected to the communications device.

A fifth aspect of the invention relates to a communications device, configured to

store identity information of the communications device and authentication information relating to the identity information, and

indicate to a network that the communications device is to be authenticated based the identity information of the communications device instead of using an identity module associated with a further network, when no identity module is operably connected to the communications device.

A sixth aspect of the invention relates to a computer program comprising program instructions for causing a set of processors comprising at least one processor to performing the method in accordance with the fourth aspect of the invention.

A seventh aspect of the invention relates to a computer program comprising program instructions for causing a set of processors comprising at least one processor to performing the method in accordance with the first aspect of the invention.

A seventh aspect of the invention relates to a method for making an emergency call from a communications device, comprising

indicating an identity of the communications device during an authentication procedure towards a network, when no identity module is operably connected to the communications device,

sending during the authentication procedure a piece of verification information based on a piece of emergency call authentication information stored in the communications device, and

establishing an emergency call via the network.

An eighth aspect of the invention relates to a method for authenticating a communications device for an emergency call, comprising

receiving information indicating an identity of the communications device instead of an identity of an identity module during an authentication procedure in a network,

authenticating the communications device based on a piece of emergency call authentication information, and

establishing an emergency call from the communications device after successful authentication of the communications device.

A ninth aspect of the invention relates to a method for providing emergency call authentication information to a communications device, comprising

authenticating an identity module relating to a communications device, and

sending to the communications device a piece of emergency call authentication information for later use after successful authentication of the identity module.

### BRIEF DESCRIPTION OF THE DRAWINGS

Embodiments of the present invention will now be described by way of example only with reference to the accompanying drawings, in which:

FIG. 1 shows schematically one example of a communication system where embodiments of the invention are applicable;

FIG. 2a shows, as an example, a flowchart of a method in accordance with an embodiment of the invention;

FIG. 2b shows, as a further example, a flowchart of a method in accordance with a further embodiment of the invention;

FIG. 3 shows, as an example, a message sequence chart for authenticating an identity module applicable in embodiments of the invention; and

FIG. 4 shows, as an example, a message sequence chart relating to authentication of a communications device in accordance with an embodiment of the invention.

### DETAILED DESCRIPTION OF EMBODIMENTS OF THE INVENTION

In the following description of the embodiments of the invention, reference is often made to an Unlicensed Mobile Access (UMA) system. It is, however, appreciated that the invention may be applicable to any other communication system where authentication for accessing a network is typically based on authentication methods of a further network. As mentioned above, authenticating a communications device towards the Wireless Local Area Network (WLAN) may be based on authentication methods of a mobile communications system.

It is also appreciated that a communications device in this description may be a dual-mode communications device. A dual-mode communications device refers to a communications device which has the necessarily functionality to communicate with two different communications networks. The communications protocols as well as the radio frequencies, for example, may be different in these two communications networks. Alternatively to being a dual-mode communications device, the communications device may support the access technology of the network 20 and only necessarily communications protocols of the further network 30. It is appreciated that the communications device may additionally support further access technologies and communications protocols. As a further alternative, the communications device may support the access technologies of the network 20 and the further network 30, but the communications device supports higher level protocols in accordance with the further network 30. In this case, the network 20 typically acts as an alternative access method for the further network 30.

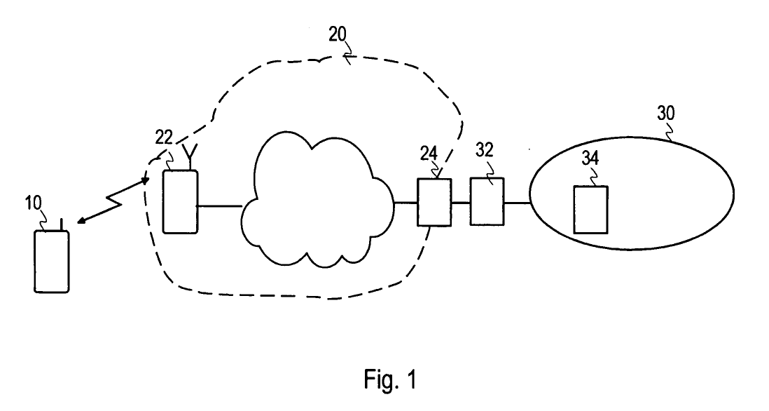

FIG. 1 shows schematically, as an example, a communications network 20 where embodiments of the invention may be applicable. The communications network 20 contains at least one transceiver network element 22 and a security server 24. A transceiver network element 22 is often called an access point. The security server 24 may be located geographically near the transceiver network element 22, or it may be connected to the transceiver network element 22 via, for example, a packet-switched data network. The communications network 20 is connected via a gateway network element 32 to a further communications network 30. The further communications network 30 contains at least a further security server 34.

It is appreciated that although FIG. 1 shows the security server 24 as a security gateway between the further network 20 and the gateway 32 relating to the further network 30, this security server 24 may be implemented as part of the gateway 32. Typically the security server 24 is operated by the operator of the network 20, when it controls access to the network 20. If the security server controls access only to the further network 30 via the gateway 32, it is typically implemented as part of the gateway 32.

A communications device 10 accessing the communications network 20 may be authenticated based on authentication methods of the further network 30. A typical solution for implementing authentication is to use a suitable authentication protocol between the communications device 10 and the security server 24 and, for example, to relay certain messages of the authentication protocol between the authentication server 24 and the further authentication server 34. Messages between the authentication server 24 and the further authentication server 34 may be transmitted using a direct link between these two servers. Alternatively, it is possible that the further authentication server 34 transmits information necessary to authenticate the communications device 10 to the authentication server 24.

As a specific example, the communication network 20 may be in accordance with the UMA standards. In this case, the security server 24 is typically an IPSec gateway, Furthermore, the authentication protocol used between the communications device 10 and the security server 24 is typically the Internet Key Exchange protocol Version 2 (IKEv2). The IKEv2 is a versatile protocol for establishing security associations for the IPSec protocol, and specific profiles have been proposed for using IKEv2 in a UMA network. A secure tunnel between the communications device 10 and the security server 24 is established using the IKEv2 protocol. Typically all traffic towards the further network 30 is sent via the security server 24, in other words the security server 24 is a security gateway. For authenticating the communications device 10 towards the further communications network 30 with authentication methods of the further communications network 30, Extensible Authentication Protocol (EAP) may be used within the IKEv2. The Extensible Authentication Protocol allows (mutual or unilateral) authentication between the communications device 10 and the security server 24 exchanging EAP messages by relaying relevant EAP messages between the security server 24 and the further authentication server 34. In other words, the further authentication server 34 may act as an EAP backend authentication server. In some connections an EAP backend authentication server is called an Authentication, Authorization and Accounting server (AAA server). The AAA server may, in turn, obtain authentication information from a subscriber information store of the further communications network.

Regarding the authentication methods of mobile communications systems, there are at least two specific EAP-based authentication protocols that may be used within the IKEv2 for authenticating identity modules: the Extensible Authentication Protocol Method for GSM Subscriber Identity Modules (EAP-SIM) and the Extensible Authentication protocol Method for 3rd Generation Authentication and Key Agreement (EAP-AKA).

It is appreciated that reference to IKEv2, EAP, EAP-SIM and EAP-AKA protocols is often made in the following description, but it is appreciated that in addition to these protocols any other suitable authentication protocols may be used in embodiments of the invention. As a skilled person may be assumed to be familiar with the basics of the IKEv2, EAP, EAP-SIM and EAP-AKA, the following description refers to these protocols without explaining details. Further details can be found in the following Internet Engineering Task Force (IETF) Requests for Comments (RFCs) and Internet-drafts: “Internet Key Exchange (IKEv2) Protocol”, draft-ietf-ipsec-ikev2-17.txt; “Extensible Authentication protocol (EAP)”, RFC3748; “Extensible Authentication Protocol Method for GSM Subscriber Identity Modules (EAP-SIM)”, draft-haverinen-pppext-eap-sim-13.txt; and “Extensible Authentication Protocol Method for UMTS Authentication and Key Agreement (EAP-AKA)”, draft-arkko-pppext-eap-aka-12.txt.

In the following it is assumed that the authentication of the communications device 10 towards the further communications network 30 is typically based on an identity module operably connected to the communications device 10. Typically this means that an identifier of the identity module is transmitted from the communications device 10 to the security server 24 in an early phase of the authentication.

Referring to the specific example of a UMA network, the identifier of the identity module is sent to the security server 24 as part of one of the initial IKEv2 messages. The security server 24 may then select a suitable further security server 34 based on the identifier of the identity module. The selected further security server 34 then initiates the EAP-SIM or EAP-AKA authentication message exchange and the security server 24 typically relays the EAP-SIM/EAP-AKA messages between the communications device 10 and the further security server 34. After a successful EAP message exchange, the IKEv2 signaling is completed and the communications device 10 is granted access to the UMA network.

When there is no identity module connected to the communications device 10, it is not possible to authenticate the communications device 10 using an identity module. Therefore the identifier sent to the communication network 10 cannot indicate an identity module. In embodiments of the invention, an identifier of the communications device is sent in an authentication message, when there is no identity module connected to the communications device. The identifier of the communications device 10 in the authentication message sent to the security server 24 may be the same identifier as the communications device 10 uses towards the further communication network 30. The further communications network may provide communications devices with identifiers, for example, for denying equipment reported stolen from accessing network or for placing emergency calls without an identity module. Alternatively, it may be any identifier associated with the communications device 10, different from identifiers of the identity modules. When the security server 24 detects that the identifier in an authentication message indicates a communications device, not an identity module, it handles the authentication differently. Identifiers of the identity modules may, for example, have a different format than identifiers of the communications devices.

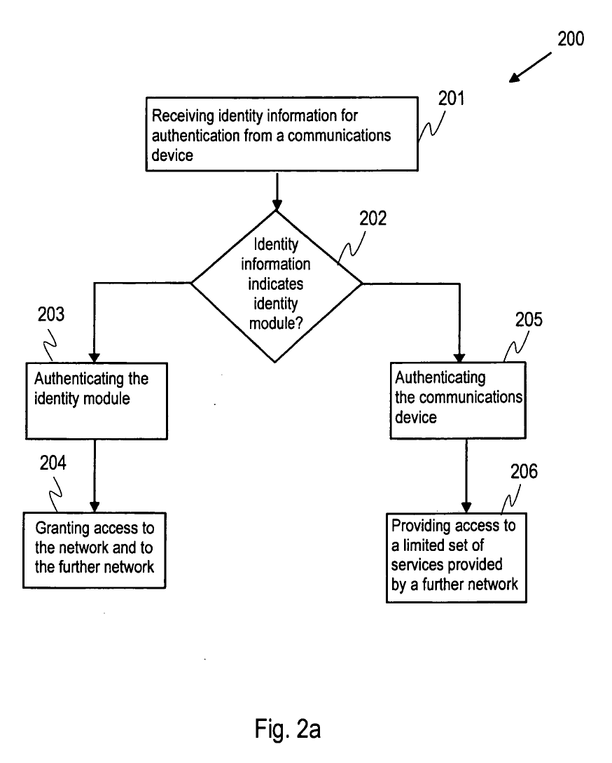

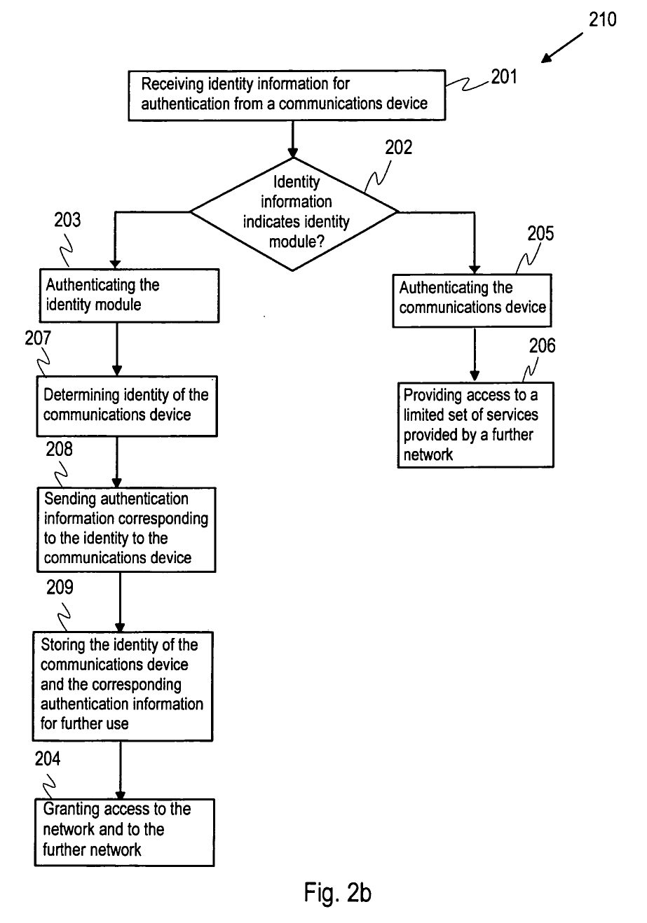

FIG. 2a shows, as an example, a flowchart of a method 200 in accordance with an embodiment of the invention. The method 200 is carried out, for example, by a security server 24.

In step 201, identity information for authentication is received from a communications device 10 in the communications network 20. In step 202, it is checked whether the identity information indicates an identity module or a communications device. As discussed above, this differentiation may be done, for example, based on the format of the identifier. Alternatively, the communications device 10 may indicate that the identifier is not an identifier of an identity module. This may be done, for example, by modifying an authentication message containing the identifier. An authentication message containing the identifier may, for example, contain also verification information, which may be absent when an identity module is to be authenticated.

In step 203, an identity module relating to the communications device 10 is authenticated, when the identity information indicates the identity module. In step 204, the communications device is granted access to the network 20 and typically also to a set of services provided by the further network 30. In general, the purpose may be to provide access to anything that the authentication to the network 30 provides access to. This is typically access to the network 30, and possibly to services based on a service-level agreement between operators of the network 20 and 30. In step 205, the communications device 10 is authenticated, when the identity information indicates the communications device. In step 206, providing to the communications device access to a subset of services provided by the further network 30 in response to a successful authentication of the communications device 10. This subset of services typically includes emergency calls.

After steps 204 and 206 the security server 24 typically informs the gateway 32 about a successful authentication and indicates which services of the further network 30 the communications device 10 may access. Alternatively, the security server 24 may indicate that the communications device, not an identity module, was authenticated. The gateway 32 may then determine the extent of access that is to be granted to the communications device. The indication may be partially implicit in that sense that simply informing the gateway 32 about a successful authentication may be interpreted by allowing access to any services the further network 30 is configured to provide to the communications device 10. Typically after step 206, the security server 24 informs the gateway 32 the communications device 10 is granted access only to a subset of services.

The authentication of the identity module in step 203 is typically based on an authentication method of the further network. Typically authentication methods are based on shared secrets, which only the entity authenticating itself and the entity checking authentication know, and/or on public key cryptography, where one entity has a private key and the other entity knows the public key corresponding to the private key.

The authentication of the communications device in step 205 may be based on any suitable authentication scheme. As an example, the communications device have been given, when earlier authenticating itself towards the network 20 successfully using an identity module, a piece of authentication information for use later for authentication without the identity module. This piece of authentication information may be sent by the network 20, for example, by the security server 24. A further alternative is to send this information from the gateway 30. The information is typically sent after the authentication of the communications device is completed. The piece of authentication information may be sent using the authentication protocol or using a different protocol, for example, using a UMA-specific protocol.

As a further example, a piece of authentication information may have been stored manually or as a factory setting in the communications device for this use. Authentication information stored in a communications device may be communications device specific, common to many communications devices, or known to any communications device. A piece of information used as a shared secret but known to any communications device is usually called a generic shared secret. Authentication information specific to a communications device and stored in the communications device may be, for example, a shared secret or a private key. In the network side, the shared secrets and/or public keys may be stored, for example, in a database. The security server authenticating the communications device needs to have access to the database or other relevant information store for being able to authenticate the communications device.

It is appreciated that if the database storing authentication information corresponding to the identities of the communications devices is common to many networks, authentication of a communications device towards one network is possible using, for example, authentication information sent earlier by another network in connection with a successful authentication using an identity module.

It is appreciated that especially if the authentication of the communications device is based on an identifier, which identifies the communications device in the further network, the further network may provide an information store (or a part of a distributed information store) for storing authentication information of communications devices.

FIG. 2b shows, as an example, a flowchart of a method 210 where the security server 24 sends to the communications device authentication information associated with the identity of the communications device for later us. The method 210 contains the same steps as the method 200 and additional steps 207 to 209. In the method 210, after successful authentication using an identity module in step 203, identity of the communications device is determined in step 207, for example by requesting the communications device to send this information. In step 208, authentication information corresponding to the identity of the communications device is sent to the communications device. This authentication information is typically a shared secret. In step 209, the identity of the communications device and the corresponding authentication information are stored by the network for further use.

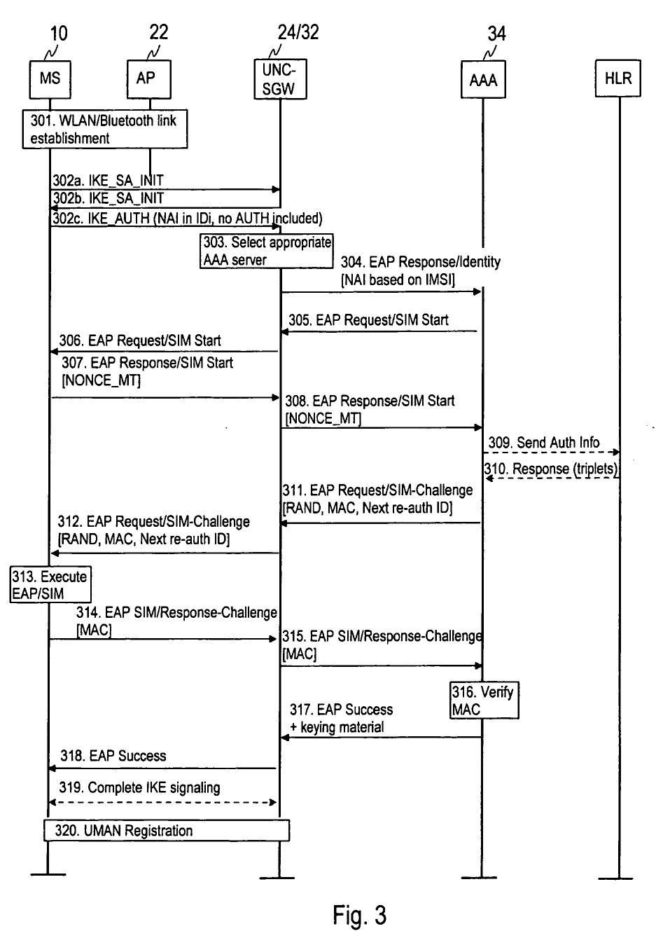

In the following, a specific embodiment of the invention is discussed in detail with reference to IKEv2 and EAP-SIM protocols. EAP-SIM relates to authentication using methods specified for GSM networks. First, the authentication of an identity module is discussed. FIG. 3 shows, as an example, a message sequence chart for authenticating an identity module.

In step 301, a communication link is established between the communications device (MS) 10 and the transceiver network element (AP) 22. In step 302, initial IKEv2 message exchange IKE_SA_INIT is carried out between the communications device 10 and the security server 24. A security association for the IKEv2 message exchange is established using the IKE_SA_INIT messages. The security association refers to defining which security procedures are used for securing the IKEv2 messages. The communications device 10 then sends an identifier of the identity module in an IKE_AUTH message. The absence of authentication payload in this authentication protocol message indicates that EAP should be used within IKEv2. The EAP type in EAP message headers indicates that EAP-SIM/AKA should be used. The format of the identity information is typically used to is used to distinguish between EAP-SIM and EAP-AKA. Typically the leading bit of the identifier indicates whether to use EAP-SIM or EAP-AKA. The security server 24 therefore selects an appropriate further authentication server 34 (AAA server) in step 303. The selection of the further authentication server 34 is typically based on the realm portion of the identifier sent by the communications device in the IKE_AUTH message. Typically identifier information indicating an identity module in the IKE_AUTH message is of the form username@realm, where the username includes at least the identifier of the identity module.

In step 304, the security server 24 sends to the selected further security server 34 a message indicating the identifier of the identity module. This message in step 304 may be, for example, an EAP Response/Identity message. The further security server 34 typically responds with an authentication message initiating the authentication between the further security server 34 and the communications device 10. The authentication message in step 305 may be, for example, an EAP Request/SIM-Start message or EAP Request/AKA-Challenge message. If the further security server 34 supports both EAP-SIM and EAP-AKA protocols, the further security server 34 may determine which protocol to use, for example, based on the identifier of the identity module. In FIG. 3, an EAP Request/SIM-Start message is shown. In step 306, the EAP Request/SIM-Start message is relayed from the security server 24 to the communications device 10. The communications device 10 responds in step 307 with an EAP Response/SIM-Start message, which the security server 24 forwards to the further security server 34 in step 308. In FIG. 3, the further security server 34 obtains at this point (steps 309, 310) a set of authentication triplets from a Home Location Register (HLR). As is known, an authentication triplet contains a random challenge, a response and a session key, where the response and the session key correspond to the challenge and are calculated using the secret shared between the HLR and the identity module. The further security server 34 continues the authentication procedure by sending an EAP Request/SIM-Challenge message in step 311, and the security server 24 forwards this message in step 312. In step 313, the communications device carries out necessary calculations and checks relating to EAP/SIM, typically together with the identity module. In step 314, the communications device 10 sends an EAP Response/SIM-Challenge message, which the security server 24 forwards in step 315. The further security server 34 verifies in step 316, a message authentication code included in the EAP Response/SIM-Challenge message. A successful verification means that an identity module having the claimed identifier is operably connected to the communications device 10. In response to successful verification, the further security server 34 sends in step 317 an EAP Success message. The security server 24 sends the EAP Success message to the communications device 10 in step 318, and thereafter the IKEv2 signaling is completed in step 319. After the authentication procedure between the communications device 10 and the security server 24 is successfully over, the communications device 10 may carry out any necessary steps for registering itself to the network 30 in step 320.

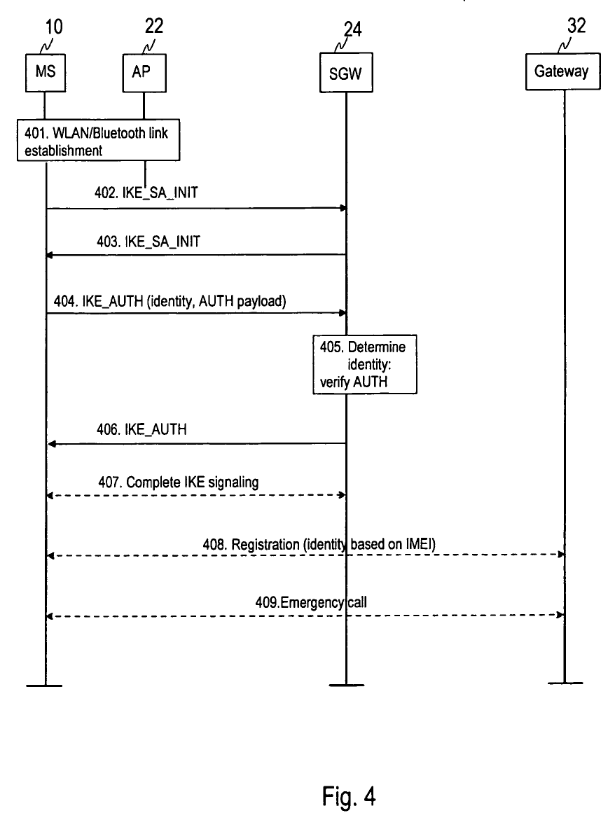

FIG. 4 shows, as an example, a message sequence chart relating to authentication of a communications device without an identity module operably connected thereto. Similarly as in step 301, a communication link is established in step 401 between the communications device 10 and the transceiver network element 22. The IKE_SA_INIT messages in steps 402 and 403 are similar to the messages in step 302. As there is no identity module operably connected to the communications device 10, the communications device should not indicate an identity module in the IKE_AUTH message in step 404, because no successful authentication of an identity module can be carried out. Therefore the communications device 10 includes into the IKE_AUTH message an identifier of the communications device. For example, in a GSM system all communications devices have an International Mobile Equipment Identity (IMEI) code. This IMEI code may be used as identifier information in the authentication message sent from the communications device 10 if this device is a dual mode device also supporting GSM. Alternatively any other communications device specific identifier may be used.

When the identifier in the IKE_AUTH message is an identifier of an identity module, this authentication message contains no verification information relating to the identifier yet. When the identifier in the IKE_AUTH message is not an identifier of an identity module, the communications device 10 may include in the IKE_AUTH message a piece of verification information corresponding to the identifier of the communications device. This way the security server 24 implementing IKEv2 will not start EAP exchange, but uses instead the verification information in the IKE_AUTH message. Alternatively—and depending on the authentication protocols and methods—this verification information may be sent in a later authentication message than the identifier of the communications device.

In step 405, the security server 24 determines, for example based on the piece of verification information in the IKE_AUTH message, that the identifier in the message does not indicate an identity module. Therefore the authentication cannot proceed as shown in FIG. 3. The security server 24 and the communications device 10 may also carry out, if needed, a further authentication message exchange at this point. If the IKE_AUTH message included AUTH payload, there may be need for no further authentication procedure. The security server 24 determines whether the communications device 10 has been successfully authenticated.

In step 406, the network 20 may authenticate itself towards the communications device 10 by sending relevant information in the IKE_AUTH message to the communications device. This authentication may be based on a shared secret and/or, for example, a digital signature using a private key. Similar authentication of the network 20 towards the communications device 10 may be carried out in step 319 in FIG. 3. In step 407, the IKEv2 signalling is completed in accordance with normal procedures.

In step 408, the communications device 10 registers itself to a gateway 32 connecting the network 20 to the further network 30. The communications device registers itself typically using the same identifier as used for authentication. The gateway 32 provides to the communications device 10 access to a subset of services only. The security server 24 typically informs the gateway 32 about the extent of the granted access, for example by indicating which identity (communications device or identity module) was authenticated. This subset of services may consist of emergency calls. In step 409, the communications device may set up the emergency call or access another service possibly belonging to the subset of services.

In a UMA network, after a communications device 10 with an identity module connected thereto has established a communication link with an access point (transceiver network element 22), the communications device first establishes a connection with a Provisioning UMA Network Controller (UNC). A connection to the Provisioning UMA Network Controller is established typically only during the very first UMA session. Thereafter connection is typically established directly with the Default UMA Network Controller. This connection establishment with the Provisioning/Default UMA Network Controller involves the IKEv2 and EAP-SIM/EAP-AKA protocol messages discussed in connection with FIG. 3. After the authentication, typically all traffic flows through the UMA Network Controller containing a UMA Security Gateway. Thereafter the communications device connects to its Default UNC, which in turn may redirect the communications device to a Serving UNC. The Provisioning UNC typically provides to the communications device information about the Default UNC. Finding the Default UNC is called UMA Discovery. The communications device registers to the Serving UNC, which may be the Default UNC, if the Default UNC does not redirect the communications device further to a separate Serving UNC.

A communications device supporting UMA may be provisioned with an IP (Internet protocol) address or a Fully Qualified Domain/host Name (FQDN) of the Provisioning UNC and the associated Security Gateway (a security server 24). In UMA, an UNC may typically be contacted only via the associated Security Gateway. This information may be stored in the communications device and/or in the identity module. Alternatively, the communications device may determine a FQND for the Provisioning UNC based on the identifier, or part thereof, of the identity module.

If the communications device 10 supporting UMA has information identifying a Security Gateway and allowing the communications device to contact the Security Gateway, authentication may be carried out in accordance with FIG. 4. If the communications device 10 supporting UMA does not have information identifying a Security Gateway and there is no identity module operably connected to the communications device 10, the communications device cannot determine a valid address (FQND or an IP address) for connecting a Security Gateway (in other words, there is no valid FQND for the UMA Discovery procedure or the registration procedure, if the communications device is already provisioned). One way to overcome this problem is to store in the communications device information indicating a default security server for situations, when there is no identity module connected to the communications device and there is need, for example, to make an emergency call. A further option to determine information identifying a security server 24 (that is, a network address or domain name of a security server 24) is to determine this information based on the possibly available cellular network coverage. For example, cellular networks typically transmit information indicating the identity of the cellular network. A domain name of a security server may be constructed based on this cellular network identifier.

As discussed in connection with FIG. 2b in a general level, it is possible that the UMA Security Gateway sends in connection with a successful authentication of the identity module to the communications device a piece of authentication information for possible later use in situations, where there is no identity module connected to the communications device. This may also apply to roaming. If the communications device contacts the UNC from abroad, the UNC can redirect the communications device to a UNC in that country. When the UNC redirects the communications device, the UNC send to the communications device authentication information for the network to which the communications device is redirected. This may be needed, for example, if the authentication information of the communications device is network-specific. The network, to which the communications device is redirected, may have access to relevant authentication information in a database or it may receive the relevant authentication information from the network redirecting the communications device. Sending a piece of authentication information to the communications device would be needed, as the communications device needs perform the authentication procedure again.

It is appreciated that typically the authentication of the identity module involves the security server 24 and a further security server 34. The authentication of the communications device typically is handled by the security server 24.

It is appreciated that the specific features discussed in connection with the specific embodiment and FIGS. 3 and 4 are also applicable in other connections than IKEv2 and EAP-SIM/EAP-AKA protocols.

It is appreciated that in the term communications device refers here to any communications device capable of communicating via a communications system. Examples of communications devices are user equipment, mobile telephones, mobile stations, personal digital assistants, laptop computers and the like. Furthermore, a communications device need not be a device directly used by human users.

It is appreciated that in this description and in the appended claims, authentication information refers to information known to the parties of the authentication, for example, to shared secrets or to private and public keys. Verification information, on the other hand, refers to information sent from the party to be authenticated to other party, and the verification information is based on the authentication information. A message authentication code calculated using a shared secret or a digital signature calculated using a private key are examples of verification information.

It is appreciated that the features discussed in connection with a specific embodiment or aspect of the invention may be combined with the features of other embodiments or aspects of the invention. Methods in accordance with the invention may be implemented as computer programs.

It is appreciated that granting to the communications device access to a set of services of a further network refers to those services provided by the further network, to which authentication of the identity module and access using an alternative access network authorizes access. This set of services may be the same set of services the identity module would be authorized to access when using a traditional access method, not the alternative access network.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for controlling network access, the method comprising
receiving identity information for authentication from a communications device in a network,
authenticating an identity module relating to the communications device and associated with a further network, when the identity information indicates the identity module,
granting to the communications device access to a set of services of the further network in response to a successful authentication of the identity module,
authenticating the communications device, when the identity information indicates the communications device, and
granting to the communications device access to a subset of the set of services of the further network in response to a successful authentication of the communications device.

2. A method as defined in claim 1, comprising receiving a portion of verification information for authenticating the communications device.

3. A method as defined in claim 2, wherein the identity information indicating the communications device and the portion of verification information are received in a same message.

4. A method as defined in claim 1, comprising sending to the communications device a portion of authentication information for later use after a successful authentication of the identity module.

5. A method as defined in claim 4, wherein the portion of authentication information relates to the identity of the communications device.

6. A method as defined in claim 1, wherein the network is an access network and the further network is cellular communications network.

7. A method as defined in claim 1, wherein the access network is a network supporting packet data communications.

8. A method as defined in claim 1, wherein the network and the further network are in accordance with one of an Unlicensed Mobile Access standard, or a 3GPP wireless local area network Internetworking standard.

9. A method as defined in claim 1, wherein the identity information is received in a message of an authentication protocol.

10. A method as defined in claim 9, wherein the authentication protocol is the Internet Key Exchange protocol version 2.

11. A communications network, configured to
receive identity information for authentication from a communications device,
authenticate an identity module relating to the communications device and associated with a further network, when the identity information indicates the identity module,
grant to the communications device access to a set of services of the further network in response to a successful authentication of the identity module,
authenticate the communications device, when the identity information indicates the communications device, and
grant to the communications device access to a subset of the set of services of the further network in response to a successful authentication of the communications device.

12. A communications network as defined in claim 11, the communications network being in accordance with at least one of a UMA standard, or a 3GPP WLAN Interworking standard.

13. A network element, configured to
receive identity information for authentication from a communications device,
authenticate an identity module relating to the communications device and associated with a further network, when the identity information indicates the identity module, and
authenticate the communications device, when the identity information indicates the communications device.

14. A network element as defined in claim 13, configured to
grant to the communications device access to a set of services of the further network in response to a successful authentication of the identity module, and
grant to the communications device access to a subset of the set of services of the further network in response to a successful authentication of the communications device.

15. A network element as defined in claim 13, wherein the network element is configured to control access to the further network.

16. A network element as defined in claim 13, comprising a security gateway.

17. A network element as defined in claim 13, wherein the network element is configured to inform the further network element about the authentication of the identity module and the communications device.

18. A network element as defined in claim 13, comprising a security server.

19. A network element as defined in claim 13, the network element being in accordance with at least one of a UMA standard, or a 3GPP WLAN Interworking standard.

20. A method of operating a communications device, the method comprising
exchanging authentication protocol messages with a network,
authenticating an identity module associated with a further network, when the identity module is operably connected to the communications device,
storing identity information of the communications device and authentication information relating to the identity information, and
indicating to the network that the communications device is to be authenticated based on the identity information of the communications device, when no identity module is operably connected to the communications device.

21. A method as defined in claim 20, wherein said step of indicating comprises sending the identity information of the communications device to the network.

22. A method as defined in claim 20, comprising sending a portion of verifying information based on said authentication information relating to the identity information of the communications device.

23. A method as defined in claim 20, comprising sending a portion of verifying information based on said authentication information and the identity information of the communications device in a same authentication protocol message.

24. A method as defined in claim 23, comprising receiving from the network authentication information for the communications device and storing the received authentication information for further use.

25. A method as defined in claim 20, wherein the identity information of the communications device is sent in response to initiating establishment of an emergency call.

26. A method as defined in claim 20, wherein the authentication protocol is the Internet Key Exchange protocol version2.

27. A method as defined in claim 20, wherein the identity of the communications device is associated with the further network.

28. A communications device, configured to
store identity information of the communications device and authentication information relating to the identity information, and
indicate to a network that the communications device is to be authenticated based the identity information of the communications device instead of using an identity module associated with a further network, when no identity module is operably connected to the communications device.

29. A computer program embodied on computer-readable medium comprising program instructions for causing a set of processors comprising at least one processor to perform the method of claim 20.

30. A computer program as defined in claim 29, embodied on a record medium, stored in a computer memory or carried on an electrical carrier signal.

31. A computer program embodied on computer readable medium comprising program instructions for causing a set of processors comprising at least one processor to performing the method of claim 1.

32. A computer program as defined in claim 31, embodied on a record medium, stored in a computer memory or carried on an electrical carrier signal.

33. A method for making an emergency call from a communications device, comprising
indicating an identity of the communications device during an authentication procedure towards a network, when no identity module is operably connected to the communications device,
sending during the authentication procedure a portion of verification information based on a portion of emergency call authentication information stored in the communications device, and
establishing an emergency call via the network.

34. A method as defined in claim 33, comprising receiving said piece of emergency call authentication information via a network.

35. A method as defined in claim 33, wherein said identity of the communications device is associated with a further network.

36. A method for authenticating a communications device for an emergency call, comprising
receiving information indicating an identity of the communications device instead of an identity of an identity module during an authentication procedure in a network,
authenticating the communications device based on a piece of emergency call authentication information, and
establishing an emergency call from the communications device after successful authentication of the communications device.

37. A method as defined in claim 36, comprising delivering to the communications device a piece of emergency call authentication information

38. A method as defined in claim 36, wherein said identity of the communications device is associated with a further network.

39. A method for providing emergency call authentication information to a communications device, comprising
authenticating an identity module relating to a communications device, and
sending to the communications device a portion of emergency call authentication information for later use after successful authentication of the identity module.
